(19) United States
(12) Patent Application Publication
(10) Pub. No.: US 2025/0277547 A1
(43) Pub. Date: Sep. 4, 2025

(54) MULTILAYER FLEXIBLE PRESSURE PIPES

(71) Applicant: Ashirvad Pipes Pvt Ltd., Bengaluru (IN)

(72) Inventors: Shireesh PANKAJ, Bangalore (IN); Vignesh PAVUNRAJ, Usilampatti (IN); R. SI-VAKUMAR, Bangalore (IN); Sunil BANTHIYA, Bangalore (IN); Ranjith KOKKOT, Bangalore (IN)

(21) Appl. No.: 18/863,631

(22) PCT Filed: May 9, 2023
(86) PCT No.: PCT/IN2023/050444

§ 371 Date: Nov. 6, 2024

(30) Foreign Application Priority Data
May 9, 2022 (IN) 202241026646

(51) Int. Cl. F16L 11/04; B32B 1/08; B32B 27/08; B32B 27/30; B32B 27/32; F16L 58/10

(52) U.S. Cl. CPC F16L 11/04; B32B 1/08; B32B 27/08; B32B 27/306; B32B 27/32; F16L 58/1009; B32B 2250/02; B32B 2250/03; B32B 2250/24; B32B 2307/7376; B32B 2597/00

(57) ABSTRACT

Disclosed is a multilayer flexible pipe (100). The multilayer flexible pipe (100) includes an outer layer (102). The outer layer (102) is made up of a modified polyolefin material. The multilayer flexible pipe (100) further includes an inner layer (104). The inner layer (104) is disposed underneath the outer layer (102). The inner layer (104) is made up of thermoplastic silicone vulcanizate. The multilayer flexible pipe (100) further includes a middle layer (106) that is disposed between the outer layer (102) and the inner layer (104) such that the middle layer (106) bonds the outer layer (102) with the inner layer (104).

### TECHNICAL FIELD

The present disclosure generally relates to a field of pipes. More specifically, the present disclosure provides multilayer flexible pipes for pressurized hot and cold potable water applications.

### BACKGROUND

In the past years, plastics pipes have considerably gained importance in the application for transporting potable water and have become an alternative for pure metal pipes. It is known that the plastic pipes are less or negligibly prone to corrosion and deposits that would erode the pipe in its long-term service life under long term pressure and ambient temperature condition. However, a drawback for the plastics pipes is the limited gamut of working temperatures at high pressure conditions and its rigidity. The most common plastic materials being used for drinking water applications are polyethylene, polypropylene random copolymer (PPR), chlorinated PVC, un-plasticised PVC etc. However, CPVC and PPR are intended for high pressure and temperature applications, and it has poor flexibility. The most commonly used HDPE materials lacks long term hydrostatic pressure at elevated temperatures and prone to oxidative degradation with chlorinated water at these conditions. Chlorinated water influences mechanical properties, structure, and characteristics of the surface of polymeric materials. The available free chlorine in a chlorinated water is a sum of aqueous hypochlorous acid (HOCl), OCl⁻ and Cl₂. The amount of undissociated HOCl determines reactivity of chlorine water at elevated temperature and pressure conditions which accelerates the process of degrading the pipe material. This corrosion is more prevalent in hot water lines because the heat makes the chlorine more active and also allows more penetration into the polymeric chain. Over the time, microcracks generates on the inner surface of the pipes and propagates through the thickness of the pipes which leads to the complete failure of the pipe.

Presently, chlorinated polyvinyl chloride (CPVC) pipes are popular for hot and cold-water application, known for excellent chlorine water resistance and being used in the market. However, the aforementioned CPVC pipes have some disadvantages including rigidity or lack of flexibility of the material, which has a negative effect during processing, transportation, installation and use. In addition, there flexible piping solutions are available in the market such as flexible PVC, elastomeric multilayer pipes, but these solutions are not recommended for hot and cold drinking water application due to the ingress of chemicals such as plasticizer, stabilizers, and other additives etc. will induce toxicity and contaminate drinking water. Further, the flexible pipes solutions cannot meet the hydrostatic pressure requirements at elevated temperatures, especially, hydrostatic pressures withstanding capability up to 90-95° C. over 10 bar pressure conditions. Another flexible pipe solution such as aluminium composite pipes have inherent rigidity which comes from Aluminium layer and customer faces difficulties in installations due to mechanical fitting solutions such as brass crimp fittings which in turn makes improper joint and causes leakages. Also, the presently available rigid piping systems and aluminium composite pipes need numerous fitting systems for installations and creating difficulties during installations for plumbers and adding cost to the customers. Furthermore, a greater number of fittings will results pressure drop at high pressure conditions. There are flexible pipes available in the market with PEX material, but the major drawback is that it cannot be recycled as they are crosslinked and also the formation of biofilm on the inner side of the pipe upon continuous exposure to water.

Therefore, there exists a need for flexible piping system intended for hot and cold drinking water application, which has a layer having antimicrobial properties, resistance to biofilm formation, oxidation resistance to hot chlorinated water and have a minimum number of fittings to minimize the pressure drop to enable easy transportation and hassle-free installations.

### SUMMARY

In view of the foregoing, a multilayer flexible pipe is disclosed. The multilayer flexible pipe includes an outer layer wherein the outer layer is made up of a modified polyolefin material. The multilayer flexible pipe further includes an inner layer that is disposed underneath the outer layer wherein the inner layer is made up of thermoplastic polymer or thermoplastic silicone vulcanizate. The multilayer flexible pipe further includes a middle layer that is disposed between the outer layer and the inner layer such that the middle layer bonds the outer layer with the inner layer.

In some embodiments of the present disclosure, the modified polyolefin is a polyethylene raised temperature (PERT).

In some embodiments of the present disclosure the outer layer is modified polyolefin based on but not limited to polyethylene raised temperature (PERT), high density polyethylene, linear low density polyethylene. Polyvinyl chloride.

In some embodiments of the present disclosure the inner layer is a modified polyolefin such as crosslinked polyethylene raised temperature (PERT), crosslinked high-density polyolefin, crosslinked linear low density polyolefin.

The crosslinking of polyolefin are done by peroxides and silanes by means of thermal or radiation cross linking.

In some embodiments of the present invention the inner layer is are fluorinated polyethylene, polyketones

In some embodiments of the present disclosure, the inner layer is a thermoplastic silicone vulcanizate is plasticizer free thermoplastic elastomer.

In all embodiments the thickness of inner layer is ranging from 100 microns to 1000 microns.

In some embodiments of the present disclosure, the middle layer is made up of Ethylene-vinyl Acetate (EVA) In some embodiments of the present disclosure, the middle layer is made up of a polymeric material having a polar and non-polar functional group. In some embodiments of the present disclosure, the outer layer has an outer diameter (OD) that is in a range of 16 millimetres (mm) to 32 mm which is suitable for plumbing application.

In some embodiments of the present invention, the multilayer piping solution having dimeter ranging from 16 mm and 200 mm or more is designed for corrosion and chemical resistant industrial applications.

In some embodiments of the present disclosure, the outer layer, the inner layer, and the middle layer are co-extruded layers.

### BRIEF DESCRIPTION OF DRAWINGS

Other objects, features, and advantages of the embodiment will be apparent from the following description when read with reference to the accompanying drawings. In the drawings, wherein like reference numerals denote corresponding parts throughout the several views:

FIG. 1 illustrates an isometric view of a multilayer flexible pipe, according to one embodiment herein; and

FIG. 2 illustrates an isometric view of the multilayer flexible pipe of FIG. 1 having a middle layer, according to another embodiment herein.

To facilitate understanding, like reference numerals have been used, where possible, to designate like elements common to the figures.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “top,” “bottom,” and the like, may be used herein for ease of description to describe one element or feature's relationship to another element(s) or feature(s) as illustrated in the figures. It is to be understood that the spatially relative terms are intended to encompass different orientations of the structure in use or operation in addition to the orientation depicted in the figures.

Embodiments described herein refer to plan views and/or cross-sectional views by way of ideal schematic views. Accordingly, the views may be modified depending on simplistic assembling or manufacturing technologies and/or tolerances. Therefore, example embodiments are not limited to those shown in the views but include modifications in configurations formed on basis of assembling process. Therefore, regions exemplified in the figures have schematic properties and shapes of regions shown in the figures exemplify specific shapes or regions of elements, and do not limit the various embodiments including the example embodiments.

As mentioned, there remains a need for a pipe for hot and cold drinking water application. Accordingly, the present disclosure provides a multilayer flexible pipe that is suitable for hot and cold-water drinking applications.

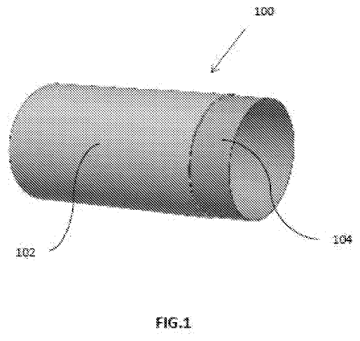

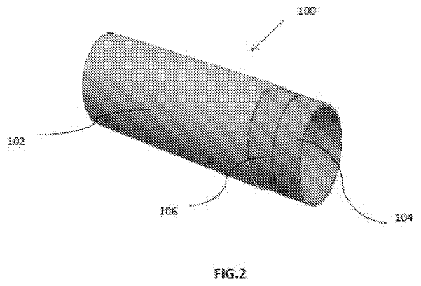

Referring now to the figures, and more particularly to FIG. 1 and FIG. 2, where similar reference characters denote corresponding features consistently throughout the figures, there are shown several embodiments.

The term “Food Grade” as used herein is used for the materials which are safe and suitable for their intended use, which shall not change in the composition of the food and transfer harmful or toxic substances into food it is holding.

The terms such as “multilayer flexible pipe”, “flexible pipe” and/or “pipe” are interchangeably used herein the context of the present disclosure.

The term “layers” or “layer” as used herein includes all the layers of the flexible pipe of the present disclosure.

FIG. 1 illustrates an isometric view of a multilayer flexible pipe (100), according to one embodiment herein. The multilayer flexible pipe (100) may be used at high hydrostatic pressure conditions with elevated temperature. The multilayer flexible pipe (100) may be suited for hot and cold-water applications. The multilayer flexible pipe (100) may include an outer layer (102) and an inner layer (104). The multilayer flexible pipe (100) may advantageously have very good resistance to oxidation with chlorinated water at elevated temperature. The multilayer flexible pipe (100) may be recycled as there is minimal crosslinking involved in the process of fabrication of the multilayer flexible pipe (100).

The outer layer (102) and the inner layer (104) may extend up to a length of the multilayer flexible pipe (100). The outer layer (102) may be positioned above the inner layer (104). In other words, the outer layer (102) may surround the inner layer (104). Specifically, the outer layer (102) may be positioned above the inner layer (104) throughout the length of the multilayer flexible pipe (100).

The outer layer (102) may be made up of a material including, but not limited to, modified polyolefin such as polyethylene raised temperature, high density polyethylene, linear low-density polyethylene, and flexible Polyvinyl Chloride (PVC). Embodiments of the present disclosure are intended to include and/or otherwise cover any type of known and later developed materials for the outer layer (102), without deviating from the scope of the present disclosure.

The inner layer (104) may be made up of a material including, but not limited to, modified polyolefin such as crosslinked polyethylene raised temperature resin, crosslinked high-density polyethylene, crosslinked linear low-density polyethylene, fluorinated polyethylene, polyketone resins, thermoplastic silicone vulcanizate. Embodiments of the present disclosure are intended to include and/or otherwise cover any type of known and later developed materials for the inner layer (104), without deviating from the scope of the present disclosure. The modified polyolefin of the inner layers are modified by peroxides and silanes or modified by either peroxide or silane by means of thermal or radiation. The inner layer (104) modified with silane or peroxide provides enhanced hot water and chlorine water oxidation in turn better chemical resistance. The modified thermoplastic inner layer (104) may advantageously make the flexible pipe (100) compatible for hot and cold drinking water applications and industrial hot water and chemical applications. The thermoplastic silicone vulcanizate material of the inner layer (104) may be plasticizer free thermoplastic elastomer. In other words, the plasticizer may not present in the thermoplastic silicone vulcanizate material of the inner layer (104) i.e., the plasticiser may be absent in the thermoplastic silicone vulcanizate material. The thermoplastic silicone vulcanizate material of the inner layer (104) may advantageously give smooth and silky feel to the inner layer (104) and may thereby impart resistance to microbes. The thermoplastic silicone vulcanizate material of the inner layer (104) may advantageously make the multilayer flexible pipe (100) compatible for hot and cold drinking water applications. The inner layer (104) made up of fluorinated polyethylene and polyketone are compatible for hot and cold drinking water applications and industrial hot water applications.

In some embodiments, the modified thermoplastic inner layer (104) may advantageously make the flexible pipe (100) compatible for hot and cold drinking water applications and industrial hot water and chemical applications.

In some embodiments, the thermoplastic silicone vulcanizate material of the inner layer (104) may impart very good antimicrobial properties due to its smooth and silky surface.

In some embodiments, thermoplastic silicone vulcanizate material of the multilayer flexible pipe (100) may be recyclable and thereby may reduce the environmental pollution.

In some embodiments, the inner layer (104) may provide antimicrobial properties, which may allow the multilayer flexible pipe (100) to be used in hot and cold-potable water applications. Specifically, the modified polyolefin material and the thermoplastic silicone vulcanizate material of the inner layer (104) may provide antimicrobial properties to the multilayer flexible pipe (100) because of its smooth and silky surface

In some embodiments, the multilayer flexible pipe (100) may be joined to another flexible pipe (not shown) by an electrofusion technique, mechanical crimp fittings, mechanical push fittings,. The electrofusion technique may use the components that may be made up of a material including, but not limited to, modified polyethylene, high-density polyethylene, polyethylene raised temperature resin, polypropylene random copolymer, nylon6, nylon 6,6 and other polyamides. The electrofusion technique and the modified polyethylene material for the components involved in the electrofusion technique may provide long term life for plumbing lines in which the multilayer flexible pipe (100) is used. The electrofusion technique may involve one or more parameters such as current, voltage, fusion time, and cooling time. The one or more parameters may be changed or controlled, while fusing/joining flexible pipes with different types and sizes.

In some embodiments, a plurality of fittings (not shown) may be required to join the multilayer flexible pipe (100) with another such pipe. In some embodiments, each fitting of the plurality of fittings may be an electrofusion fitting. In some embodiments, each fitting of the plurality of fittings may be made up of a material, including but not limited to, modified polyolefin, polyethylene raised temperature, high density polyethylene, polypropylene random copolymer, nylon 6 Nylon 6,6 and other polyamides.

In some embodiments, the outer layer (102), the inner layer (104), and each fitting of the plurality of fittings may be made up of same material that may enable better compatibility and proper joint through electrofusion technique. The electrofusion technique may advantageously provide long term life for the plumbing lines, which are hidden behind walls, floors, false ceilings etc. of a building. Thus, the plumbing lines may not require much repair, therefore, joining the multilayer flexible pipe (100) with another such pipe by the electrofusion technique may avoid breaking of the walls and ceilings.

In some embodiments the flexible piping system used mechanical jointing methods.

The mechanical jointing methods includes but not limited to crimping, push fittings, expansion fittings. The mechanical fittings are made up of materials that include brass, copper, modified polyolefins, high-density polyethylene, polyethylene raised temperature, nylon 6, nylon66, polypropylene random copolymer, polyphenyl sulfone (PPSU), polysulfone (PSU), polyethersulfone (PESU).

In some embodiments, the multilayer flexible pipe (100) may have an outer diameter that may be in a range of 16 millimetres (mm) to 32 mm. Preferably, the multilayer flexible pipe (100) may have the outer diameter that may be 16 mm, 20 mm, 25 mm, and 32 mm. The outer diameter of the multilayer flexible pipe (100) may be kept such that the multilayer flexible pipe (100) may be bent by hand of a worker to make a sweep bend of the multilayer flexible pipe (100). This may advantageously reduce installation time and pressure loss in the multilayer flexible pipe (100).

In some embodiments, the multilayer pipe (100) having dimeter ranging from 16 mm and 200 mm or more is designed for corrosion and chemical resistant industrial applications. In some embodiments, while installing the multilayer flexible pipe (100), there may be a requirement of lesser number of fittings and joints. Thus, the installation of the multilayer flexible pipe (100) may be much easier.

In some embodiments, the outer layer (102) may be made up of a material including, but not limited to, modified polyolefin. The inner layer (104) may be made up of a material, including, but not limited to, cross-linked polyolefin such as Polyethylene raised temperature, high density polyethylene, linear low density polyethylene, fluorinated polyethylene, polyketone. The modified polyolefin material of the outer layer (102) and the cross-linked polyolefin material or fluorinated polyolefin or polyketone or thermoplastic silicone vulcanizate of the inner layer (104) provide better chlorine resistance, resistance to biofilm formation and hydrostatic pressure strength at high temperature.

In some embodiments, the outer layer (102) may be made up of a material including, but not limited to, polyethylene raised temperature (PERT) high-density polyethylene (HDPE), linear low density polyethylene (LLDPE) ( ) flexible polyvinyl chloride (PVC)

The inner layer (104) may be made up of a material including, but not limited to, modified polyolefin such as, cross linked polyethylene raised temperature, cross linked high-density polyethylene, cross linked linear low density polyethylene, fluorinated polyethylene, polyketone and thermoplastic silicone vulcanizate. The modified polyolefin and the crosslinked polyolefin material of the inner layer (104) may enable enhanced oxidation resistance and improved chlorine water resistance. The modified polyolefin and the crosslinked polyolefin material of the inner layer (104) may increase long-term hydrostatic pressure withstanding capacity of the multilayer flexible pipe (100) that may allow the multilayer flexible pipe (100) to withstand higher hydrostatic pressure at high temperature. The modified polyolefin and the crosslinked polyolefin material of the inner layer (104) provides the excellent resistance to biofilm formation even in continuous water flow.

FIG. 2 illustrates an isometric view of the multilayer flexible pipe (100) of FIG. 1 having a middle layer (106), according to another embodiment herein. The middle layer (106) may be positioned between the outer layer (102) and the inner layer (104).

The middle layer (106) may be adapted to bond the outer layer (102) with the inner layer (104) such that the outer layer (102) and the inner layer (104) exhibits a good integrity. In some embodiments of the present disclosure, the middle layer (106) may be coated with a sticky material that may be adapted to bond the outer layer (102) to the inner layer (104).

In some embodiments, the middle layer (106) may be made up of a material including, but not limited to, Ethylene-vinyl Acetate (EVA), acrylic polymers, etc. Embodiments of the present disclosure are intended to include and/or otherwise cover any type of known and later developed material for the middle layer (106), without deviating from the scope of the present disclosure.

In some embodiments, the middle layer (106) may be made up of a material having a polymeric structure. The polymeric structure may include a polar functional group and a non-polar functional group. The polar functional group and the non-polar functional group may enable better tying/bonding between the outer layer (102) and the inner layer (104).

In some embodiments, the multilayer flexible pipe (100) may be joined with another such pipe by way of a solvent fusion joining technique.

In some embodiments, the multilayer flexible pipe (100) may be made up of a modified polyolefinic material that may exhibit highly crystalline and bimodal molecular architecture in a polymer chain. The highly crystalline and bimodal molecular architecture in the polymer chain may enhance flexibility and long-term hydrostatic pressure strength of the multilayer flexible pipe (100) up to 95° C.

In some embodiments, the outer layer (102) may be made up of a material including, but not limited to, modified polyethylene, polyethylene raised temperature resin, poly-vinyl chloride (PVC), high-density polyethylene, linear low density polyethylene,. The inner layer (104) may be made up of a material including, but not limited to, modified polyolefin or crosslinked polyolefin such as polyethylene raised temperature (PERT), high density polyethylene, linear low density polyethylene, fluorinated polyethylene, polyketone and thermoplastic silicone vulcanizate. The modified PVC material of the outer layer (102) and the modified polyolefin or crosslinked polyolefin material of the inner layer (104) may enable the multilayer flexible pipe (100) to operate at conditions of hot and cold drinking water applications. The cross-linked polyolefin or modified polyolefin material such as fluorinated polyethylene, polyketone of the inner layer (104) may provide adequate long-term hydrostatic pressure withstanding capabilities and chlorine water resistance at elevated temperatures up to 95° C. The cross-linked polyolefin or modified polyolefin material of the inner layer (104) may provide resistance to biofilm formation with dynamic water flow.

In some embodiments, the crosslinked polyolefin or modified polyolefin or thermoplastic silicon vulcanizate may be co-extruded as the inner layer (104) with modified polyolefin or plasticized PVC as outer layer (102) and also the middle layer (106) at respective processing conditions.

In some embodiments, the flexible PVC material of the outer layer (102) may be used for hot and cold drinking water applications which have food grade cross linked polyolefin or modified polyolefin as inner layer (104).

In all the above mentioned multilayer flexible pipe (100), the extent of flexibility and minimum bending radius may be varied and it may purely depend on the type of materials used for inner layer (104) and the outer layer (102) and dimensions of the multilayer flexible pipe (100).

In all embodiments the thickness of inner layer is ranging from 100 microns to 1000 microns, especially 100 microns to 500 microns.

Certain advantages pertaining to the multilayer flexible pipe (100) are listed hereinbelow:
The multilayer flexible pipe (100) may require only few numbers of fittings, hence facilitate easy installation.
The deployment of the multilayer flexible pipe (100) may allow bends and sweeps to be formed by hand, which in turn may reduce installation time and pressure loss in the multilayer flexible pipe (100) by the use of minimum number of fittings and joints.
The modified polyolefin or crosslinked polyolefin material for the inner layer (104) of the multilayer flexible pipe (100) may enable enhanced oxidation resistance, resistance to biofilm formation and improved chlorine water resistance at high temperature and long-term hydrostatic pressure.
The modified polyolefin or crosslinked polyolefin material of the inner layer (104) along with flexible PVC material of the outer layer (102) may provide long term hydrostatic pressure strength at elevated temperature. Further, the modified polyolefin or crosslinked polyolefin material of the inner layer (104) and the flexible PVC material of the outer layer (102) may facilitate the multilayer flexible pipe (100) to be bonded with another such pipe by using solvent fusion technology.
The multilayer flexible pipe (100) may have very good resistance to oxidation, when chlorinated water is passed through the multilayer flexible pipe (100) at elevated temperature due to its modified polyolefin or crosslinked polyolefinic or thermoplastic silicone vulcanizate, inner layer
The thermoplastic silicone vulcanizate material of the inner layer (104) of the multilayer flexible pipe (100) may be plasticizer free and, therefore: making the multilayer flexible pipe (100) compatible with drinking water applications. Also, the thermoplastic silicone vulcanizate material of the inner layer (104) may impart very good antimicrobial properties due to its smooth and silky surface.
The modified polyolefin and the thermoplastic silicone vulcanizate material of the multilayer flexible pipe (100) are recyclable and thereby reducing the environmental pollution.

The foregoing discussion of the present disclosure has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present disclosure has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed:

1. A multilayer flexible pipe (100) comprising:
an outer layer (102), wherein the outer layer (102) is made up of a modified polyolefin material;
an inner layer (104) that is disposed underneath the outer layer (102), wherein the inner layer (104) is made up of cross linked polyethylene raised temperature (PERT).

2. The multilayer flexible pipe (100) as claimed in claim 1, wherein the inner layer (104) is disposed underneath the outer layer (102), wherein the inner layer (104) is made up of thermoplastic silicone vulcanizate.

3. The multilayer flexible pipe (100) as claimed in claim 1, wherein the inner layer (104) is disposed underneath the outer layer (102), wherein the inner layer (104) is made up of fluorinated polyethylene.

4. The multilayer flexible pipe (100) as claimed in claim 1, wherein the inner layer (104) is disposed underneath the outer layer (102), wherein the inner layer (104) is made up of polyketone.

5. The multilayer flexible pipe (100) as claimed in claim 1, wherein the inner layer (104) is disposed underneath the outer layer (102) wherein the inner layer (104) having a thickness ranging from 100 microns to 1000 microns, especially 100 microns to 500 microns, specifically 100 microns to 300 microns.

6. The multilayer flexible pipe (100) as claimed in claim 1, wherein the crosslinked inner layer of polyethylene raised temperature (PERT) is modified by peroxides and silanes or modified by either peroxide or silane by means of thermal or radiation.

7. The multilayer flexible pipe (100) as claimed in claim 1, wherein the inner layer (104) is modified with silane or peroxide provides enhanced hot water and chlorine water oxidation in turn enhanced chemical resistance.

8. The multilayer flexible pipe (100) as claimed in claim 2, wherein the thermoplastic silicone vulcanizate is plasticizer free thermoplastic elastomer.

9. The multilayer flexible pipe (100) as claimed in claim 1, further comprising a middle layer (106) that is disposed between the outer layer (102) and the inner layer (104) such that the middle layer (106) bonds the outer layer (102) with the inner layer (104).

10. The multilayer flexible pipe (100) as claimed in claim 1, wherein the outer layer (102) is made up of a material including, but not limited to, modified poly-vinyl chloride (PVC), fluorinated polyethylene, polyketone.

11. The multilayer flexible pipe (100) as claimed in claim 1, wherein the inner layer (104) is made up of a material including, but not limited to crosslinked polyolefin such as polyethylene raised temperature (PERT), high density polyethylene, linear low density polyethylene, fluorinated polyethylene, polyketone.

12. The multilayer flexible pipe (100) as claimed in claim 9, wherein the middle layer (106) is made up of Ethylene-vinyl Acetate (EVA).

13. The multilayer flexible pipe (100) as claimed in claim 9, wherein the outer layer (102), the inner layer (104), and the middle layer (106) are co-extruded layers.

14. The multilayer flexible pipe (100) as claimed in claim 1, wherein the outer layer (102) has an outer diameter (OD) that is in a range of 16 millimetres (mm) to 32 mm.

15. The multilayer flexible pipe (100) as claimed in claim 1, wherein the outer layer (102) has an outer dimeter ranging from 16 millimetres (mm) and 200 mm.

16. The multilayer flexible pipe (100) as claimed in claim 1, wherein the multilayer flexible pipe (100) is joined to another flexible pipe by an electrofusion technique, mechanical joints, mechanical crimp fittings, and mechanical push fittings.

17. The multilayer flexible pipe (100) as claimed in claim 16, wherein the electrofusion technique requires components that are made up of a material including, but not limited to, modified polyethylene, high-density polyethylene, polyethylene raised temperature resin, polypropylene random copolymer, nylon6, nylon 6,6 and other polyamides.

18. The multilayer flexible pipe (100) as claimed in claim 16, wherein the mechanical joints are made up of materials that include brass, copper, polyethylene raised temperature (PERT), nylon 6, nylon66, polypropylene random copolymer, polyphenyl sulfone (PPSU), polysulfone (PSU), polyethersulfone (PESU).

19. The multilayer flexible pipe (100) as claimed in claim 10, wherein a crosslinked polyolefin material of the inner layer (104) and the flexible PVC material of the outer layer (102) facilitates the multilayer flexible pipe (100) to be bonded with another such pipe by solvent fusion technology.

20. The multilayer flexible pipe (100) as claimed in claim 1, wherein only few numbers of fittings are required to install the multilayer flexible pipe (100).

21. The multilayer flexible pipe (100) as claimed in claim 1, allows bends and sweeps to be formed by hand.

22. The multilayer flexible pipe (100) as claimed in claim 1, wherein the multilayer flexible pipe (100) enables enhanced oxidation resistance, resistance to biofilm formation and improved chlorine water resistance at high temperature and long-term hydrostatic pressure.
